(19) United States
(12) Patent Application Publication
(10) Pub. No.: US 2003/0203080 A1
(43) Pub. Date: Oct. 30, 2003

(54) Vacuum or modified atmosphere package for foods which tend to release liquids and/or gases

(75) Inventors: Luigi Garavaglia, Cornaredo (IT); Mauro Bonvini, Manerbio (IT); Fabio Rubechini, Camucia-Cortona (IT)

Correspondence Address: AKERMAN SENTERFITT, P.O. BOX 3188, WEST PALM BEACH, FL, 33402-3188, US

(73) Assignee: SIRAP-GEMA S.p.A., Verolanuova (IT)

(21) Appl. No.: 10/402,488

(22) Filed: Mar. 28, 2003

(30) Foreign Application Priority Data
Mar. 29, 2002 (IT) MI2002A 000678

(51) Int. Cl. A23B 4/00

(52) U.S. Cl. 426/127

(57) ABSTRACT

A vacuum or modified atmosphere package for food products which are susceptible to release liquids and/or gases. The package has 1) a tray made of plastic material, having a bottom and sidewalls terminating with a jutting edge. The tray includes at least two layers, of which an inward-facing layer is a sheet of a substantially open-cell expanded thermoplastic material having holes or slots on at least part of its upper surface, and a lower outward-facing layer of a gas-barrier composite film. The tray further has a peripheral frame made of plastic material and having barrier properties with respect to the diffusion of gases, the peripheral frame coupled to the tray edge all around the perimeter thereof and having substantially listel-like sides with an angular cross-section comprising two flanges of which a first flange juts out as a prolongation of the tray edge and a second flange engages the tray edge from beneath. The package also has 2) a food product susceptible of releasing liquids and/or gases placed onto the bottom of the tray, and 3) a cover for the tray consisting of a gas-barrier composite film which adheres onto the first flange of the peripheral frame and, optionally, onto the tray edge so as to maintain a vacuum or a modified atmosphere within the package.

### DESCRIPTION

1. Field of Application

In its broader aspect, the present invention relates to the field of modified atmosphere packaging or vacuum packaging of food products by means of packages made of plastic material.

In particular, the invention relates to a package for food products comprising a tray made of thermoplastic material, having barrier properties with respect to the gases diffusion and having absorbing power with respect to any liquid released by the food products, and a hermetically sealed cover for said tray.

Moreover, the present invention relates to a tray to be used in the aforesaid package and a process for the preparation of such tray.

2. Prior Art

The use of containers made of plastic material for packaging food products is quite widespread, above all for the retail sale in supermarkets. In case of easily perishable food products, such as meat and fish, the problem arises of extending as much as possible the period for which the food products maintains substantially unaltered its organoleptic, nutritional and hygienic characteristics and maintains an aspect as identical as possible to that of the fresh product.

In order to solve such problem, various solutions have been proposed, among which those of vacuum packaging and modified atmosphere packaging are the most used.

Examples of application of such techniques of vacuum packaging or modified atmosphere packaging can be found, for example, in the patents U.S. Pat. No. 3,574,642, U.S. Pat. No. 5,115,624 and in the international application WO 97/36504.

There essentially exist three packaging techniques, of which the first foresees the use of a tray of expanded plastic material on the bottom of which the food product is laid, whereby afterwards the tray is closed with a gas-permeable film and inserted inside a bag which is impermeable to gases. The air contained inside the bag is then replaced either by washing with a mixture of inert gases (generally nitrogen and carbon dioxide) or by applying vacuum and then introducing the aforesaid mixture of inert gases.

The second technique foresees instead the use of a tray of expanded plastic material wrapped externally by a gas-impermeable film. The food product is placed onto the bottom of the tray and this is closed by means of a plastic material film which is impermeable to gases. In this case as well, before achieving a complete sealing of the tray, a modified atmosphere is set inside it in the above mentioned way. In this respect, reference can be made to U.S. Pat. No. 5,744,181.

The third technique foresees the use of a tray made of expanded plastic material which is rendered gas-impermeable through the coupling of a film provided with gas-barrier properties onto the inner face of the tray. Before sealing it with a cover of gas-barrier film, the replacement of the air inside the package with a suitable gas mixture is carried out.

A drawback of the tray obtained by means of the aforesaid third technique is the impossibility of absorbing the liquids released by the food products, apart from using an absorbing pad between the food product and the bottom of the tray, which, however negatively influences the production costs, complicates the operations of disposal and recycle of the packages after use, and can contribute to the microbiological proliferation.

A problem which has been encountered with the first two above mentioned techniques is the impossibility of removing completely the oxygen from the inner atmosphere of the tray, as the closed-cell structure of the trays in expanded plastic material holds air, notwithstanding the application of vacuum or the washing with gases. The air is then released gradually in the space above the food product, so modifying the original composition of the gas mixture.

For this reason, it has been proposed to add into the packages provided with an outer bag, chemical substances adapted to neutralise the residual oxygen (“oxygen scavengers”), such as iron and its derivatives in presence of acids (U.S. Pat. No. 5,698,250).

It is clear, however, that such a solution implies relevant additional costs and eventual risk of contamination of the food products.

An improved technical solution with respect to U.S. Pat. No. 5,698,250, recently proposed in the Patent Application WO 00/26113 foresees the use of a tray in open-cell plastic material, instead of the conventional trays in closed-cell plastic material, inside the packaging system with the above described outer bag. In this way, the need of adding the “oxygen scavengers” inside the packages is eliminated.

Again, in the aforesaid patent application, reference is made to the possibility of absorbing any liquid released by the food product by means of an absorbing pad arranged between the food product and the bottom of the tray.

Patent Application WO 00/46125 describes a tray having absorbing properties which is suitable for vacuum packaging or modified atmosphere packaging of food products which may release liquids. Such a tray consists of a structure made of open cell plastic material enclosed between two films of which at least one is impermeable to the gases respectively applied onto its inner and outer surface. The film applied onto the inner surface is interrupted by perforations in order to allow the liquid to penetrate into a predetermined portion of the underlying open-cell structure. According to an embodiment of the above mentioned tray, said portion is sealed by welding the two films in predetermined points in order to prevent the liquid provided inside it from migrating into the remaining open-cell structure of the tray.

As an alternative, the films may be welded or glued in correspondence of the cutting surfaces provided at the ends of the edge in order to prevent the liquid from migrating outside of the tray.

However in the above indicated solutions, a gas migration occurs along the open-cell plastic material thus reaching an equilibrium with the atmosphere outside of the tray in correspondence of the cutting surfaces. This phenomenon achieves the undesired effect of altering the modified atmosphere originally set inside the tray, thereby the shelf-life of the food product cannot be extended.

Further on, the realisation of an open-cell plastic material structure with two barrier films implies not negligible additional costs and the compression of the two films in order to avoid free gases diffusion through the cutting surfaces reduces the absorption to a small portion of the bottom of the tray.

The technical problem at the basis of the present invention is that of providing a package for modified atmosphere packaging or vacuum packaging of food products susceptible of releasing liquids and/or gases which would be of easier and more economical manufacture, which would be more effective with regard to the absorption of liquids and/or exudates released by foods and which would allow to maintain substantially unaltered the gas atmosphere set inside it or the vacuum before use.

### SUMMARY OF THE INVENTION

Such a technical problem is solved, according to the invention, by a vacuum or modified atmosphere package for food products which are susceptible to release liquids and/or gases, said package comprising:

a tray made of plastics material, having a bottom, and having sidewalls terminating with a jutting edge, the tray comprising at least two layers, of which a layer facing inward of the tray consists of a sheet of a substantially open-cells expanded thermoplastic material having holes or slots on at least part of its upper surface, and a lower layer facing outward of said tray consists of a gas-barrier composite film; the tray further having a peripheral frame made of plastic material and having barrier properties with respect to the diffusion of gases, the peripheral frame being coupled to the tray edge all around the perimeter thereof and having substantially listel-like sides with an angular cross-section comprising two flanges of which a first flange juts out as a prolongation of the tray edge and a second flange engages the tray edge from beneath;

a food product susceptible of releasing liquids placed onto the bottom of said tray; and

a cover for said tray consisting of a gas-barrier composite film which adheres onto the first flange of the peripheral frame and, optionally, onto the tray edge so as to maintain a vacuum or a modified atmosphere within the package.

Preferably, the peripheral frame has listel-like sides with a substantially L-shaped, Z-shaped or C-shaped cross-section.

According to the present invention, the peripheral frame is made of a thermoplastic material and is capable of preventing the diffusion of the gases outward of the tray.

The peripheral frame is preferably obtained by injecting in a mould a molten thermoplastic material directly on the tray edge so as to make them integral to each other.

Alternatively, the peripheral frame can be pre-formed in a suitable mould from a thermoplastic material and then coupled to the tray edge in a conventional way, for example by heat seal, ultrasonic welding or adhesives, preferably by heat seal. In this way, the peripheral frame is made integral with the tray edge so preventing the diffusion of the gases outward of the tray.

The peripheral frame can also be obtained from a sheet of thermoplastic material having a gas-barrier composite film on at least one of its surfaces, said film being intended to be coupled to the tray edge. In that case, the peripheral frame results to be impermeable to gases in addition to prevent the diffusion of the gases outward of the tray. The thermoplastic material of said peripheral frame or of said sheet from which the peripheral frame is obtained can be expanded by means of physical or chemical agents or can be unexpanded. The expanded thermoplastic material has a structure with closed cells.

Preferably, the thermoplastic material of said peripheral frame is compact and unexpanded.

Preferably, the expanded thermoplastic material has a thickness in the 1 to 4 mm range, and a density of 10 to 700 g/l.

Preferably, the unexpanded thermoplastic material has a thickness in the range of 0.7 to 4 mm.

The thermoplastic material of the peripheral frame or of the sheet from which the peripheral frame is obtained, is selected from a group comprising ethylene vinyl acetate, polystyrene, polypropylene, polyethylene, polyethylene terephthalate, polyvinyl chloride and copolymers thereof. Polyethylene in any of its grades and ethylene vinyl acetate are particularly preferred.

The tray of the package according to the invention preferably comprises the aforementioned inward- and outward-facing layers and comprises, over the inward-facing layer, an additional layer consisting of a film or sheet of unexpanded plastic material having through holes or slots on at least the bottom of the tray.

Alternatively, a plastic material composite film having gas-barrier properties may be used instead of the film or sheet of unexpanded plastic material.

Advantageously, said unexpanded film or sheet, or said gas-barrier composite film is rendered opaque to allow the concealment of the absorbed liquid. For example, the opacification can be achieved by incorporating titanium dioxide into the plastic material.

The gas-barrier composite film forming the cover is bonded conventionally, preferably heat sealed, to the peripheral molding flange that juts out from the tray edge and optionally to the tray edge as well.

This film may be identical to the gas-barrier composite films which form the outward-facing layer of the tray and the additional layer over the inward-facing layer of the tray, and also may be identical to the gas-barrier composite film of the peripheral frame.

Preferably, the gas-barrier composite films of the package according to the invention are each a multilayer film comprising at least one gas-barrier layer of plastic material, a thermoplastic material layer, and a bonding outer layer. Of course, additional layers may be provided to provide the film with the desired thickness and mechanical characteristics.

The material of the gas-barrier layer can be selected from a group comprising polymers or copolymers of ethylene vinyl alcohol (EVOH), nylon, polyvinylidene chloride (PVDC), poly- or copolyamides and combinations thereof. A preferred material is a polymer or copolymer of ethylene vinyl alcohol and/or nylon.

The material of the bonding outer layer of the gas-barrier film is selected from a group comprising polyethylene (PE) and/or copolymers thereof, in particular ethylene vinyl acetate (EVA), polypropylene (PP) and copolymers thereof.

Examples of multilayer barrier films of the above type, that are suitable for use in this invention, are described in U.S. Pat. No. 4,735,855.

Examples of particularly preferred gas-barrier multilayer films are multilayer films sold by the firm B-PACK, which are 50 to 60 micron thick and comprise a gas barrier layer of EVOH, a polystyrene (PS) layer, and a bonding outer layer of polyethylene (PE).

Further examples of particularly preferred gas-barrier multilayer films, are the LID Cryovac multilayer barrier films having a thickness of about 25 micron.

The plastic material forming the substantially open-cells expanded plastics sheet and the unexpanded film or sheet of the tray, is preferably selected from the group comprising polystyrene, polypropylene, polyethylene, polyethylene terephthalate, polyvinyl chloride, and copolymers thereof. Polystyrene is particularly preferred.

The grams per square meter of the open-cell thermoplastic material sheet is preferably comprised in the range of 150 to 450 g/m².

Preferably, at least one surfactant is incorporated into the substantially open-cell sheet. This can be achieved conventionally during the sheet forming process.

The surfactant provides the open-cell thermoplastic sheet material with a capability to absorb aqueous liquids.

It can be selected from conventional anionic, cationic and non-ionic surfactants, and is preferably a salt of a sulphonic acid having formula R-SO₃H, or of a sulphuric ester having formula R-OSO₃H, where R is selected from the group comprising alkyl and aryl alkyl, with an alkaline or alkaline-earth metal.

A surfactant that is particularly useful in this invention is an aliphatic sulphonate sold by the firm NOVACROME under the tradename HOSTASTAT SYSTEM E 3904®.

Where a product to be packaged is also susceptible of releasing smelly volatile substances (e.g. fish, egg-based food, etc.), the open-cell expanded plastic material layer advantageously contains a finely divided solid material effective to absorb the aforesaid smelly substances.

The solid material is preferably selected from a group comprising alumina, bentonite, caolin, activated carbon, zeolites, and high-melting synthetic polymers such as polyphenyl oxide and polyimides, graphite, mica, diatomaceous earth, pumice, and clay.

The package of the invention enables perishable food products, such as meat and fish, to be preserved for several days at no significant loss of their organoleptic and microbiological properties, while concealing exudate and absorbing any smelly volatile substances into the open-cell expanded plastic material layer.

In addition, the package of the invention has the advantage in that it maintains the atmosphere originally set inside it because the gas diffusion outward is prevented, such that the characteristics of the packaged product will not be impaired during the storage time set for it.

In fact, it should be noted that in the package according to the invention the gas transportation through the cutting surfaces of the tray edge is prevented because these surfaces are folded over and bonded to the first flange jutting out of the edge, and are bonded to the second flange that engages the edge from beneath.

In addition, the gas-barrier composite film that forms the cover is applied over the first flange jutting out from the edge to seal the package tight and prevent any gas exchange with the outside.

Furthermore, in the package of the invention, air inside the tray can be removed by virtue of the open-cell structure of the expanded plastic material layer, and optionally replaced with a gaseous medium of a desired composition selected as a function of the product being packaged.

This is achieved at lower costs for materials and equipment than those implied by the use of the technology which employs the external gas-impermeable bag (WO 00/26113).

Further on, the absorption of the liquids released by the food products is not provided by the interposition of an absorbing pad between the food product and the bottom of the tray, but rather by exploiting the absorbing properties of the layer of expanded open-cells plastic material containing a surfactant.

The use of a material different from the plastic material of which the tray consists is thus avoided, i.e. a cellulosic material such as paper or paperboard, thus facilitating the disposal or recycle operations of the packages after their use.

Further on, an effective absorption of the liquids is achieved, even in conditions of inclined position of the tray, by perforating the entire upper surface of the open-cells expanded thermoplastic material sheet.

According to an embodiment of the present invention, the tray of the aforesaid package comprises two layers and is obtained through a process according to any one of the claims 29, 30 and 34 to 42.

According to a another embodiment of the present invention, the tray of the aforesaid package comprises three layers and is obtained through a process according to any one of the claims 31 to 39 and 43 to 46.

The way of obtaining the sheets of open-cell expanded thermoplastic material is well known in technical literature; see for example Klempner and Frisch “Handbook of Polymeric Foams and Foam Technology”, Carl Hanser Verlag, 1991. Specific processes are for example described in EP-A-0 090 507, U.S. Pat. No. 3,610,509, EP-A-0 642 and EP 0 849 309.

The coupling of the layer of open-cells thermoplastic material with the gas-barrier composite film and with the non-expanded layer may be achieved by means of hot rolling, use of adhesives or any other method conventionally used for this purpose.

The coupling by means of hot rolling is particularly preferred. For instance, the sheet of open-cells thermoplastic material, obtained through the conventional techniques of annular or flat-head extrusion with injection of expanding gases, may be initially hot-rolled with a non-expanded film or sheet obtained through coextrusion or subsequently extruded through the techniques known as “extrusion coating”, obtaining a first composite sheet.

Such first composite sheet is perforated on one face thereof and rolled on the other face thereof, in-line or out-of-line, with a gas-barrier composite film. This latter rolling operation is preferably carried out at a temperature comprised in the range 185-210° C. whereas the rolling of the sheet of open-cells thermoplastic material with a non-expanded film or sheet is preferably carried out at a temperature of 160-180° C.

The holes or slots in the non-expanded film or sheet and in the sheet of open-cells thermoplastic material may be made in a conventional way, for example by means of punching machines. Such perforations allow the passage of the liquid released by the food product contained in the tray into the sheet of open-cells thermoplastic material.

The forming of the semi-finished tray is carried out in a conventional way, preferably by thermoforming in a dedicated mould at a temperature comprised in the range 160-220° C. In particular, said thermoforming operations may be carried out in sequence in a single mould or in different moulds using suitable conventional methods, such as vacuum suction, compressed air injection, mechanical methods, etc.

The peripheral frame is preferably obtained by injecting in a mould a molten thermoplastic material directly on the tray edge so as to make them integral to each other. According to this procedure, the tray is housed into the mould provided with suitable cavities into which the molten thermoplastic material is injected by an appropriate system. In such cavities, the molten thermoplastic material will come into contact with the tray edge so producing a peripheral frame with listel-like sides rendered integral by melting to the tray edge and comprising a first flange jutting out of the tray edge and a second flange rendered integral by melting to the tray edge from beneath;

The peripheral frame can also be pre-formed and then applied to the tray edge, for example by heat seal. In this way, the peripheral frame is formed in a mould provided with suitable cavities into which the molten thermoplastic material is injected by an appropriate system and the thermoplastic material solidifies so forming the frame. Alternatively, the peripheral frame can be obtained from a expanded or unexpanded thermoplastic material sheet having closed-cells. A gas-barrier composite film is conventionally coupled to at least one side of this sheet, preferably by hot rolling.

The resulting composite sheet is then shaped conventionally, e.g. thermoformed or deep drawn, to provide its edges with an angular cross-section comprising two flanges.

A center portion of appropriate size can be removed conventionally, e.g. by die cutting, from the shaped composite sheet to leave a peripheral frame having listel-like sides which will be coupled to the edges of the semi-finished tray.

The package according to the present invention is obtained by means of procedures already known in the art, for example from the U.S. Pat. No. 5,744,181.

According to such procedures, the food product to be packed is placed onto the bottom of the above described tray and the tray is sealed under vacuum or under modified atmosphere by adhering a gas-barrier composite film onto the peripheral frame flange jutting out of the tray edge and optionally also on the proper edge of the tray preferably by heat seal.

The package according to the invention may be under vacuum or under modified atmosphere. In the latter case, the modified atmosphere is obtained through application of vacuum and subsequent injection of inert gases, such as nitrogen and carbon dioxide, or of mixture containing oxygen according to the kind of food product to be packed and preserved.

The technical problem underlying the present invention is also solved, according to another embodiment of the invention, by a vacuum or modified atmosphere package for food products which are susceptible to release liquids and/or gases, said package comprising:

a tray made of plastics material, having a bottom, and having sidewalls terminating with a jutting edge, the tray comprising at least two layers, of which a layer facing inward of the tray consists of a sheet of a substantially open-cells expanded thermoplastic material having holes or slots on at least part of its upper surface, and a lower layer facing outward of said tray consists of a composite film having barrier properties with respect to the diffusion of gases; the outward facing lower layer being engaged with the inward facing layer along all its lower surface and terminating with a portion jutting out of the tray edge as a prolongation thereof,

a food product susceptible of releasing liquids and/or gases placed onto the bottom of said tray; and

a cover for said tray consisting of a gas-barrier composite film which adheres onto said portion jutting out of the tray edge and, optionally, onto the tray edge so as to maintain a vacuum or a modified atmosphere within the package.

Preferably, the inward-facing layer contains a surfactant.

The tray with two layers of said package can be obtained by a method as claimed in claim 47.

Preferably, said package further includes, over said inward-facing layer, a layer consisting of an unexpanded plastic material film or sheet, or consisting of a gas-barrier composite film having holes or slots on at least the bottom tray.

This tray with three layers can be formed by a method as claimed in claim 48.

The features and advantages of the invention should become understood from the following description of preferred embodiments of the food package, said description being given by way of a non-limiting indication with reference to the accompanying drawings.

### BRIEF DESCRIPTION OF THE DRAWINGS

In the drawings:

FIG. 1 is a perspective view of a package according to the invention;

FIG. 2 is a sectional view of the package of FIG. 1 taken along line II-II;

FIG. 3 is an exploded perspective view of the package depicted in FIG. 1, with the package tray shown cutaway;

FIG. 4 is an enlarged detail view of the tray of FIG. 3;

FIG. 5 is a sectional view of a package according to another embodiment of the present invention,

FIG. 6 is an exploded perspective view of a package according to a further embodiment of the present invention, with the package tray shown cutaway,

FIG. 7 is an enlarged detail view of the tray of FIG. 6, and

FIG. 8 is a sectional view of a further embodiment of the package according to the invention.

### DETAILED DESCRIPTION

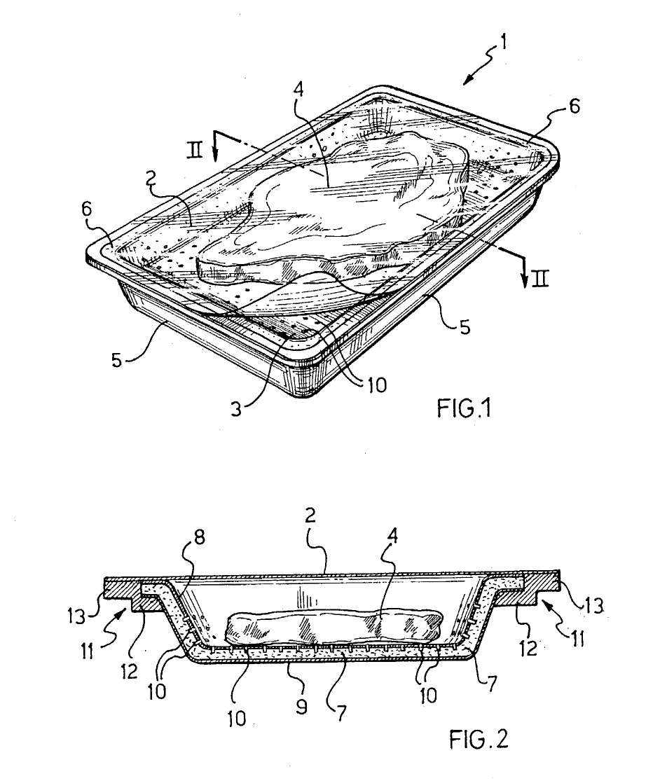

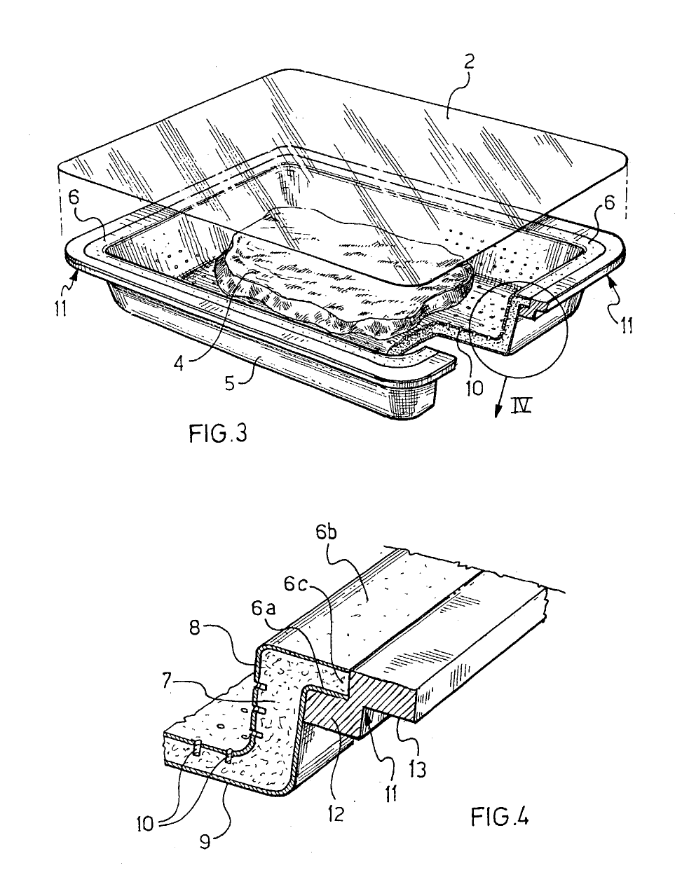

Referring to FIGS. 1 to 4, a package according to the invention comprises a tray 1 and a cover 2.

The tray 1 has a bottom 3 on which a food product 4 is placed before its packaging, and has sidewalls 5 terminating with a jutting edge having a lower surface 6a, an upper surface 6b, and an end or cutting surface 6c.

The tray structure comprises a substantially open-cell expanded polystyrene sheet 7 having an upper surface covered with a film 8 of unexpanded polystyrene, and having a lower surface covered with a multilayer film 9 that includes a gas-barrier layer of either EVOH or nylon.

The film 8 is formed with a plurality of holes 10 of a selected diameter, which extend into the thickness of the expanded polystyrene sheet 7 by a predetermined amount so as to allow the liquid released by the food product 4, e.g. shares of a meat product, to penetrate into the substantially open cells of the sheet 7 passing through the holes 10.

In particular, the open cell structure of the sheet 7 has a close network of capillary void channels which put the single cells in communication to each other and allow them to receive and keep the liquid penetrated through the aforesaid holes 10.

In this way, the liquid is kept like by a sponge, and, because of the strong capillary interactions between the void channels and the liquid, it cannot return onto the upper surface of the bottom 3 of the tray 1 by passing through the holes 10, even if this is inclined or even turned upside down.

The penetration of the liquid is also enhanced by the presence of a surfactant in the sheet 7; the surfactant, in fact, remarkably reduces the natural water repellency of the plastic material, increasing the adhesion forces between the solid (plastic material) and the liquid until these overcome the cohesion forces between the molecules of the liquid, thus allowing the liquid to penetrate into the structure provided with substantially open cells of the sheet 7 through the holes 10.

According to the present invention, the package further comprises a peripheral frame 11 coupled or rendered integral to the tray edge 6 all around its perimeter by either injecting the thermoplastic material into a suitable mould containing the tray or heat sealing a pre-formed peripheral frame with the tray edge.

More particularly, the peripheral frame 11 has listel-like sides with a substantially Z-shaped cross-section. Of course, other cross-sectional shapes than a Z-shape could be provided, such as an L-shaped cross section or C-shaped cross section.

In this embodiment of the peripheral frame 11, the listel-like sides have essentially two flanges: a first flange 12 integral to the lower surface 6a of the edge 6, and a second flange 13 integral to the end or cutting surface 6c of the edge 6.

In addition, the second flange 13 juts out from the edge 6 as a prolongation thereof.

Preferably, the structure of the peripheral frame 11 consists of an expanded thermoplastic material with closed cells or a unexpanded thermoplastic material.

Thanks to the process according to the invention, this thermoplastic material is bonded or rendered integral permanently to the material of the end or cutting surface 6c and of the multilayer barrier film 9 on the lower surface 6a of the edge 6. In this way, any gas exchange with the environment through the end or trimming surface 6c is prevented.

The cover 2 consists of a multilayer barrier film and is heat sealed to the tray so as to bond it permanently to the thermoplastic material of the peripheral frame 11 along the second flange 13 and, optionally, to the unexpanded polystyrene film 8 on the upper surface 6b of the edge 6.

The cover 2 is applied at the end of the packaging process, after vacuuming the interior and/or modifying the atmosphere of the tray 1 loaded with the product 4.

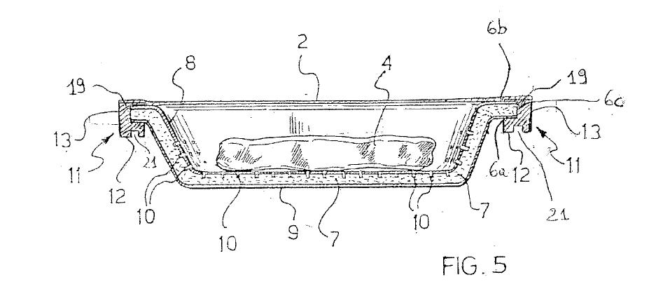

FIGS. 5 to 8 show further embodiments of the package according to the invention. In such figures, the same or equivalent elements as those of the package shown in FIGS. 1-4 carry the same reference numerals.

In particular, in the embodiment of the invention package shown in FIG. 5, the peripheral frame 11 has listel-like sides with substantially C-shaped angular cross section. The listel-like sides comprises a first flange 12 rendered integral to the lower surface 6a of the tray edge 6, a second flange 13 rendered integral to the end or cutting surface 6c of the tray edge 6 and jutted out of the edge 6 as a prolongation thereof, and a third flange 19 located over the tray edge 6 and rendered integral to the upper surface 6b of the edge 6.

The peripheral frame also comprises a perimeter groove 21 located in the first flange 12 which has substantially the function of reducing the weight of said peripheral frame.

The cover 2 is heat sealed to the tray so as to bond it permanently to the thermoplastic material of the peripheral frame 11 along the third flange 19 and, optionally, to the unexpanded polystyrene film 8 on the upper surface 6b of the edge 6.

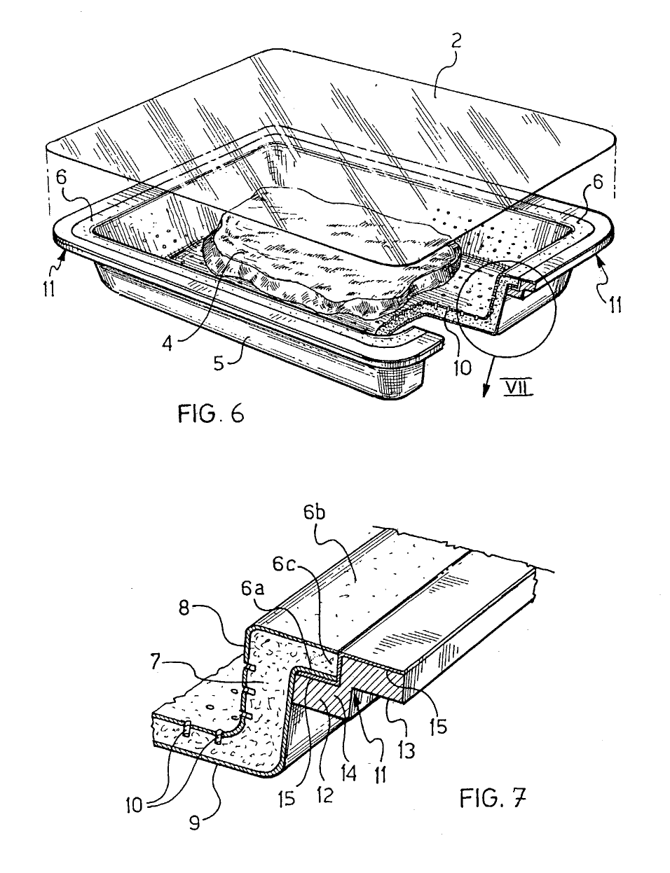

In the embodiment of the package shown in FIGS. 6 and 7, the peripheral frame 11 has listel-like sides with substantially Z-shaped angular cross section. The structure of the peripheral frame 11 consists of a substrate 14 of an expanded thermoplastic material with closed cells or of an unexpanded thermoplastic material which is covered on its top with a composite film 15 having gas-barrier properties.

With the process according to the invention, the peripheral frame 11 is coupled to the edge 6 of the tray 1 so as to permanently bond the multilayer barrier film 15 of the peripheral frame 11 to the material of the end or cutting surface 6c and of the multilayer barrier film 9 on the lower surface 6a of the edge 6. In this way, any gas exchange with the environment through the end or trimming surface 6c is prevented.

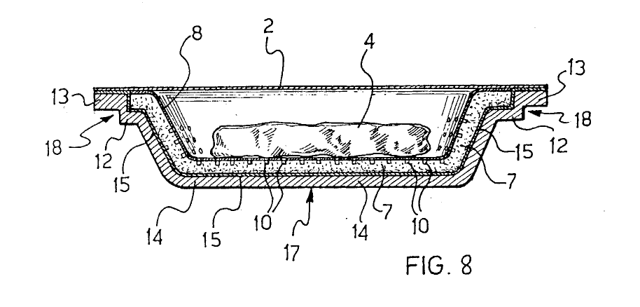

In the embodiment of the invention package shown in FIG. 8, the gas-barrier multilayer film 9 of the tray 1 is now replaced by a composite layer 17 of a gas-barrier plastic material comprising a substrate 14 of a closed-cell expanded thermoplastic material or unexpanded thermoplastic material covered with a composite film 15 having a gas-barrier properties. This composite film 15 is bonded along the whole lower surface of the substantially open-cell expanded polystyrene sheet 7.

Also, the composite layer 17 ends up in a portion 18 having listel-like sides of substantially Z-shaped cross-section, said edge portion 18 being fully equivalent of the peripheral frame 11 of the package shown in FIGS. 1-4.

In fact, said portion with listel-like sides has essentially two flanges of which a first flange 12 is bonded to the lower surface of the substantially open-cell polystyrene sheet 7 around the tray edge, and a second flange 13 is bonded to the end or trimming surface 6c of the edge 6 and juts out from the latter. In this way, all gas exchange with the environment through the end or trimming surface 6c is prevented.

Additionally to the previously mentioned advantages, the package of this invention has an advantage in that the liquid issuing from the food product can be absorbed to the whole interior surface of the tray by virtue of its construction providing an absorptive intermediate layer formed from a substantially open-cell thermoplastic sheet material. Furthermore, any smelly volatile substances released by the product (e.g. fish) can be absorbed into the active compositions incorporated in the open-cell porous sheet.

An additional advantage of the package according to the invention comes from the effectiveness of the tray being heat sealed to the peripheral molding, since the operation admits of the sealed materials being identical or highly compatible with each other.

### EXAMPLE 1

With a procedure similar to that described in the Patent Application EP 0 849 309, a sheet made of expanded polystyrene with substantially open cells (a percentage higher than 80%), having a weight (grams per square meter) of 350 g/m², a thickness of 4,5 mm and a density of 60 g/l, was prepared by extrusion of a suitable mixture.

The sheet so produced was immediately sent to a hot rolling station in which a OPS-type opacified non-expanded polystyrene film, having a thickness of 25 micron, was applied in correspondence of a surface of such sheet by rolling at a temperature of 160° C. The composite sheet thus obtained was perforated in correspondence of the free surface of the non-expanded polystyrene film by means of a plurality of metal nails and in such a way to extend the perforation to a portion of the open-cells expanded polystyrene sheet.

Thereafter, a multilayered barrier film of the PE//EVOH//PS type, produced by B-pack and having a thickness of 60 micron was applied in correspondence of the free surface of the aforesaid sheet, thus obtaining a perforated composite sheet. This last rolling was carried out at a temperature of 170° C. and a conveying speed of 15 m/min.

Finally, the perforated composite sheet was sent into a thermoforming machine wherein it was taken to an average temperature of 200° C. and then thermoformed in a suitable mould obtaining a semi-finished tray.

The semi-finished tray was placed in a mould provided with cavities into which a molten low-density polyethylene (LDPE) was injected so as to form on the semi-finished tray edge, after cooling of the low-density polyethylene, a peripheral frame having listel-like sides with Z-shaped angular cross-section comprising two flanges of which one jutted out of the tray edge and the other was integral by melting to the tray edge from beneath.

The low-density polyethylene was of the Lupolen 1800 S type sold by the firm Basel and having a melting flow index (MFI)=20. A low-density linear polyethylene (LLDPE) can also be used instead of the low-density polyethylene to improve the welding of the peripheral frame.

The injection of the molten low-density polyethylene into the mould cavities was performed at a rate of 8 cycles/minute and the low-density polyethylene had a temperature of 180-200° C. and a pressure of 300 bar.

The tray so obtained was sent to a packaging machine comprising a chamber equipped with a suitable mould and with apertures for the air intake and/or the inlet of a gaseous mixture.

After having put the food product to be packed into the aforesaid tray, the tray was placed inside the aforesaid chamber together with a cover hold above it. The cover consisted of a multilayered barrier film of the PE/EVOH/PE type and had a thickness of 50 micron.

The chamber was then closed, the air contained therein was evacuated by applying a reduced pressure of 1-4 millibar and afterwards a gaseous mixture consisting of 70% oxygen and 30% carbon dioxide was introduced into the chamber.

As soon as the introduction of the aforesaid gas into the chamber had been completed, the aforesaid cover was heat welded onto the peripheral frame of the tray obtaining a package according to the invention.

### EXAMPLE 2

A package according to the invention was produced according to the example 1 with the exception that the peripheral frame was pre-formed in a suitable mould and then coupled to the semi-finished tray edge by heat sealing.

A molten low-density polyethylene (LDPE) was injected in a mould provided with cavities so as to form, after cooling of the low-density polyethylene, a peripheral frame having listel-like sides with Z-shaped angular cross-section.

The low-density polyethylene was of the Lupolen 1800 S type sold by the firm Basel and having a melting flow index (MFI)=20. A linear low-density polyethylene (LLDPE) can also be used instead of the low-density polyethylene to improve the welding of the peripheral frame.

The injection of the molten low-density polyethylene into the mould cavities was performed at a rate of 8 cycles/minute and the low-density polyethylene had a temperature of 180-200° C. and a pressure of 300 bar.

Then, the peripheral frame was coupled to the semi-finished tray in a suitable station. The heat-seal operations were performed at a temperature of 135-150° C. and a pressure of 2-6 atmosphere for a time of 0.5-1.5 minutes and the peripheral frame was joined by melting to the semi-finished tray edge in such a way to have one of the peripheral frame flanges that juts out of the tray edge and the other flange that is integral to the tray edge from beneath.

### EXAMPLE 3

In this example of production of the package according to the invention, the semi-finished tray was prepared according to the example 1 and then coupled to a peripheral frame which was pre-formed from a sheet of thermoplastic material covered with a gas-barrier composite film on one of its surfaces.

A sheet of closed-cell expanded polystyrene having a density of 10 to 100 g/l was provided by a conventional procedure and then a multilayer barrier film of the PE//EVOH//PS type, manufactured by B-pack, which was 60-micron thick was applied on one of the two sheet surfaces, to yield a gas-barrier expanded composite sheet.

The application of the multilayer barrier film was performed by a lamination process carried out at a temperature of 180° C. and a conveying rate of 15 m/min.

The gas-barrier expanded composite sheet was transferred to a machine comprising a preheating, thermoforming and die-cutting station, where a center portion of the sheet was removed to leave a peripheral frame having listel-like sides of Z-shaped angular cross-section with two flanges for use with said semi-finished tray.

At this stage, the semi-finished tray was slipped into the cutout of said thermoformed gas-barrier expanded sheet for bonding to the peripheral frame.

Alternatively, the peripheral frame could be fitted onto the semi-finished tray once prepared as previously described.

In a suitable station, the heat sealing operations where then carried out at a temperature of 135° to 150° C. under a pressure of 2 to 6 atmospheres for 0.5 to 1.5 seconds, thereby heat sealing the peripheral frame to the edge of the semi-finished tray such that one of the peripheral flange flanges jutted out from the edge and the other engaged the edge from beneath.

Finally, the peripheral frame now sealed to the tray edge was die-cut to desired final dimensions for a finished tray according to the invention.

The finished tray was transferred to a packaging machine comprising a chamber equipped with a suitable mould and with apertures for the air intake and/or the inlet of a gaseous mixture.

After having put the food product to be packed into the aforesaid tray, the tray was placed inside the aforesaid chamber together with a cover hold above it. The cover consisted of a multilayered barrier film of the PE/EVOH/PE type and had a thickness of 50 micron.

The chamber was then closed, the air contained therein was evacuated by applying a reduced pressure of 1-4 millibar and afterwards a gaseous mixture consisting of 70% oxygen and 30% carbon dioxide was introduced into the chamber. As soon as the introduction of the aforesaid gas into the chamber had been completed, the aforesaid cover was heat welded onto the peripheral frame of the tray obtaining a package according to the invention.

1. A vacuum or modified atmosphere package for food products which are susceptible to release liquids and/or gases, said package comprising:
a tray made of plastic material, having a bottom, and having sidewalls terminating with a jutting edge, the tray comprising at least two layers, of which a layer facing inward of the tray consists of a sheet of a substantially open-cell expanded thermoplastic material having holes or slots on at least part of its upper surface, and a lower layer facing outward of said tray consists of a gas-barrier composite film; the tray further having a peripheral frame made of plastic material and having barrier properties with respect to the diffusion of gases, the peripheral frame being coupled to the tray edge all around the perimeter thereof and having substantially listel-like sides with an angular cross-section comprising two flanges of which a first flange juts out as a prolongation of the tray edge and a second flange engages the tray edge from beneath;
a food product susceptible of releasing liquids and/or gases placed onto the bottom of said tray; and
a cover for said tray consisting of a gas-barrier composite film which adheres onto the first flange of the peripheral frame and, optionally, onto the tray edge so as to maintain a vacuum or a modified atmosphere within the package.

2. A package according to claim 1, wherein said angular cross-section is a substantially L-shaped or Z-shaped or C-shaped cross-section.

3. A package according to claim 1, wherein said inward-facing layer incorporates at least one surfactant.

4. A package according to claim 1 further comprising a layer overlying said layer facing inward of the tray and consisting of a unexpanded plastic material film or sheet or of a gas-barrier composite film having holes or slots on at least said bottom.

5. A package according to claim 4, wherein said unexpanded film or sheet or said gas-barrier composite film forming the layer over the inward-facing layer is opacified.

6. A package according to claim 1, wherein the plastic material of said substantially open-cells expanded thermoplastic sheet material is selected from a group comprising polystyrene, polypropylene, polyethylene, polyethylene terephtalate, polyvinyl chloride, and copolymers thereof.

7. A package according to claim 4, wherein the plastic material of said substantially open-cells expanded thermoplastic sheet material and said unexpanded film or sheet is selected from a group comprising polystyrene, polypropylene, polyethylene, polyethylene terephtalate, polyvinyl chloride, and copolymers thereof.

8. A package according to claim 7, wherein said plastic material is polystyrene.

9. A package according to claim 1, wherein the peripheral frame is formed by injecting in a mould a molten thermoplastic material to the tray edge and cooling said molten thermoplastic material.

10. A package according to claim 1, wherein the peripheral frame is formed by injecting in a mould a molten thermoplastic material and then coupled to the tray edge by heat sealing.

11. A package according to claim 1, wherein the peripheral frame is formed from a sheet of thermoplastic material having a gas-barrier composite film laminated on at least one surface thereof, said film being appropriate to bond to the tray edge.

12. A package according to claim 9, wherein the thermoplastic material of the peripheral frame or of the sheet forming the peripheral frame is selected from a group comprising polystyrene, polypropylene, polyethylene in any of its grades, polyethylene terephtalate, polyvinyl chloride, and copolymers thereof.

13. A package according to claim 12, wherein said thermoplastic material is unexpanded compact or expanded with closed cells.

14. A package according to claim 1, wherein said gas-barrier composite films are each a multilayer film comprising at least one gas barrier layer of plastic material and at least one thermoplastic material layer.

15. A package according to claim 14, wherein the plastic material of said gas-barrier layer is selected from a group comprising polymers and copolymers of ethylene vinyl alcohol (EVOH), nylon, polyvinylidene chloride (PVDC), poly- or copolyamides and combinations thereof.

16. A package according to claim 15, wherein said plastic material is a polymer or copolymer of ethylene vinyl alcohol or nylon.

17. A package according to claim 14, wherein said gas-barrier composite films are of the same plastic material.

18. A package according to claim 1, wherein said open-cell expanded thermoplastic material layer facing inward of the tray contains a finely divided solid material effective to absorb any smelly volatile substances released from said food product.

19. A package according to claim 18, wherein said finely divided solid material is selected from a group comprising alumina, bentonite, caolin, activated carbon, zeolites, and high-melting synthetic polymers such as polyphenyl oxide and polyimides, graphite, mica, diatomaceous earth, pumice, and clay.

20. A vacuum or modified atmosphere package for food products which are susceptible to release liquids and/or gases, said package comprising:
a tray made of plastics material, having a bottom, and having sidewalls terminating with a jutting edge, the tray comprising at least two layers, of which a layer facing inward of the tray consists of a sheet of a substantially open-cells expanded thermoplastic material having holes or slots on at least part of its upper surface, and a lower layer facing outward of said tray consists of a composite film having barrier properties with respect to the diffusion of gases; the outward facing lower layer being engaged with the inward facing layer along all its lower surface and terminating with a portion jutting out of the tray edge as a prolongation thereof,
a food product susceptible of releasing liquids and/or gases placed onto the bottom of said tray; and
a cover for said tray consisting of a gas-barrier composite film which adheres onto said portion jutting out of the tray edge and, optionally, onto the tray edge so as to maintain a vacuum or a modified atmosphere within the package.

21. A package according to claim 20, wherein said inward-facing layer incorporates at least one surfactant.

22. A package according to claim 20 further comprising a layer overlying said inward-facing layer and consisting of an unexpanded plastic material film or sheet or of a gas-barrier composite film having holes or slots on at least said bottom.

23. A tray for use in a vacuum or modified atmosphere package for food products which are susceptible to release liquids and/or gases, the tray being made of plastic material, having a bottom, and sidewalls terminating with a jutting edge, the package comprising the tray and a cover for the tray consisting of a gas-barrier composite film, the tray comprising:
at least two layers, of which a layer facing inward of the tray consists of a sheet of a substantially open-cells expanded thermoplastic material having holes or slots on at least part of its upper surface, and a lower layer facing outward of said tray consists of a gas-barrier composite film;
a peripheral frame made of plastic material and having barrier properties with respect to the diffusion of gases, the peripheral frame being coupled to the tray edge all around the perimeter thereof and having substantially listel-like sides with an angular cross-section comprising two flanges of which a first flange juts out as a prolongation of the tray edge and a second flange engages the tray edge from beneath,
wherein the cover can adhere onto the first flange of-the peripheral frame and, optionally, onto the tray edge so as to maintain a vacuum or a modified atmosphere within the package.

24. A tray according to claim 23, wherein said inward-facing layer incorporates at least one surfactant.

25. A tray according to claim 23, further comprising a layer overlying said inward-facing layer and consisting of a unexpanded plastic material film or sheet or of a gas-barrier composite film having holes or slots on at least said bottom.

26. A tray for use in a vacuum or modified atmosphere package for food products which are susceptible to release liquids and/or gases, said tray made of plastics material and having a bottom and sidewalls terminating with a jutting edge and comprising:
at least two layers, of which a layer facing inward of the tray consists of a sheet of a substantially open-cell expanded thermoplastic material having holes or slots on at least part of its upper surface, and a lower layer facing outward of said tray consists of a composite film having barrier properties with respect to the diffusion of gases;
the outward facing lower layer being engaged with the inward facing layer along all its lower surface and terminating with a portion jutting out of the tray edge as a prolongation thereof.

27. A tray according to claim 26, wherein said inward-facing layer incorporates at least one surfactant.

28. A tray according to claim 26, further comprising a layer overlying said inward-facing layer and consisting of an unexpanded plastic material film or sheet or of a gas-barrier composite film having holes or slots on at least said bottom.

29. A method of making a tray for use in a vacuum or modified atmosphere package for food products which are susceptible to release liquids and/or gases, the tray being made of plastic material, having a bottom, and sidewalls terminating with a jutting edge, the package comprising the tray and a cover for the tray consisting of a gas-barrier composite film, the tray comprising:
at least two layers, of which a layer facing inward of the tray consists of a sheet of a substantially open-cells expanded thermoplastic material having holes or slots on at least part of its upper surface, and a lower layer facing outward of said tray consists of a gas-barrier composite film; and
a peripheral frame made of plastic material and having barrier properties with respect to the diffusion of gases, the peripheral frame being coupled to the tray edge all around the perimeter thereof and having substantially listel-like sides with an angular cross-section comprising two flanges of which a first flange juts out as a prolongation of the tray edge and a second flange engages the tray edge from beneath,
the method comprising the steps of:
providing a sheet of expanded thermoplastic material with substantially open cells optionally containing at least one surfactant;
coupling a gas-barrier composite film onto a surface of said sheet of expanded thermoplastic material;
making a series of holes or slots in said sheet of expanded thermoplastic material in correspondence of at least part of its uncoupled surface, said holes or slots extending into at least part of the thickness of said sheet of expanded thermoplastic material, obtaining a perforated composite sheet;
forming the perforated composite sheet in such a way as to obtain a semi-finished tray having a bottom and side walls terminating in an edge and wherein said gas-barrier composite film defines the lower layer of said semi-finished tray;
providing a peripheral frame of a plastic material having barrier properties with respect to the gas-diffusion for bonding to the edge of said semi-finished tray, the peripheral frame having substantially listel-like sides with an angular cross-section including two flanges; and
coupling the peripheral frame to the edge of said semi-finished tray such that one of said flanges juts out from the edge as a prolongation thereof, and the other engages the edge from beneath, thereby obtaining said tray.

30. A method according to claim 29, wherein said coupling step is carried out by hot rolling said sheet of expanded thermoplastic material with said gas-barrier composite film.

31. A method of making a tray for use in a vacuum or modified atmosphere package for food products which are susceptible to release liquids and/or gases, the tray being made of plastic material, having a bottom, and sidewalls terminating with a jutting edge, the package comprising the tray and a cover for the tray consisting of a gas-barrier composite film, the tray comprising:
at least two layers, of which a layer facing inward of the tray consists of a sheet of a substantially open-cells expanded thermoplastic material having holes or slots on at least part of its upper surface, and a lower layer facing outward of said tray consists of a gas-barrier composite film;
a layer overlying said inward-facing layer and consisting of a unexpanded plastic material film or sheet or of a gas-barrier composite film having holes or slots on at least said bottom; and
a peripheral frame made of plastic material and having barrier properties with respect to the diffusion of gases, the peripheral frame being coupled to the tray edge all around the perimeter thereof and having substantially listel-like sides with an angular cross-section comprising two flanges of which a first flange juts out as a prolongation of the tray edge and a second flange engages the tray edge from beneath,
the method comprising the steps of:
providing a sheet of expanded thermoplastic material with substantially open cells optionally containing at least one surfactant;
coupling an unexpanded plastic material film or sheet onto a surface of said sheet of expanded thermoplastic material, thus obtaining a first composite sheet;
making a series of holes or slots in said first composite sheet in correspondence of at least part of the uncoupled surface of said unexpanded film or sheet, said holes or slots extending into at least part of the thickness of said sheet of expanded thermoplastic material, obtaining a first perforated composite sheet;
coupling a gas-barrier composite film made of plastic material onto the first perforated composite sheet in correspondence of the free surface of said sheet of expanded thermoplastic material, thus obtaining a second perforated composite sheet;
forming the second perforated composite sheet in such a way as to obtain a semi-finished tray having a bottom and side walls terminating in an edge and wherein said gas-barrier composite film defines the lower layer of said semi-finished tray;
providing a peripheral frame of a plastic material having barrier properties with respect to the gas-diffusion for bonding to the edge of said semi-finished tray, the peripheral frame having substantially listel-like sides with an angular cross-section including two flanges; and
coupling the peripheral frame to the edge of said semi-finished tray such that one of said flanges juts out from the edge as a prolongation thereof, and the other engages the edge from beneath, thereby obtaining said tray.

32. A method according to claim 31, wherein said coupling step of the unexpanded plastic material film or sheet with a surface of said expanded thermoplastic material sheet is carried out by hot rolling.

33. A method according to claim 31, wherein said coupling step of the said gas-barrier composite film of plastic material with said first perforated composite sheet is carried out by hot rolling.

34. A method according to claim 29, wherein the peripheral frame for bonding to the edge of said-finished tray is formed by a process comprising the steps of:
providing a sheet of thermoplastic material;
coupling a gas-barrier composite film onto at least one surface of said sheet of thermoplastic material, thereby obtaining a composite sheet;
shaping the composite sheet to give its edges an angular cross-sectional shape including two flanges; and
removing a central portion of the shaped composite sheet to obtain said peripheral frame for bonding to the edge of said semi-finished tray by means of said gas-barrier composite film.

35. A method according to claim 34, wherein the thermoplastic material of said sheet is an unexpanded thermoplastic material or expanded thermoplastic material with closed-cells.

36. A method according to claim 34, wherein said shaping step of the composite sheet is carried out by a thermoforming or deep drawing operation.

37. A method according to claim 34, wherein said removing step is carried out by a die-cutting operation.

38. A method according to claim 29, wherein said peripheral frame is bonded to the semi-finished tray edge by heat sealing, ultrasonic welding, or adhesive means.

39. A method according to claim 29, wherein the peripheral frame for coupling with the semi-finished tray edge is formed by injecting a molten thermoplastic material in a suitable mould and cooling said molten thermoplastic material.

40. A method of making a tray for use in a vacuum or modified atmosphere package for food products which are susceptible to release liquids and/or gases, the tray being made of plastic material, having a bottom, and sidewalls terminating with a jutting edge, the package comprising the tray and a cover for the tray consisting of a gas-barrier composite film, the tray comprising:
at least two layers, of which a layer facing inward of the tray consists of a sheet of a substantially open-cells expanded thermoplastic material having holes or slots on at least part of its upper surface, and a lower layer facing outward of said tray consists of a gas-barrier composite film;
a peripheral frame made of plastic material and having barrier properties with respect to the diffusion of gases, the peripheral frame being coupled to the tray edge all around the perimeter thereof and having substantially listel-like sides with an angular cross-section comprising two flanges of which a first flange juts out as a prolongation of the tray edge and a second flange engages the tray edge from beneath,
wherein the cover can adhere onto the first flange of the peripheral frame and, optionally, onto the tray edge so as to maintain a vacuum or a modified atmosphere within the package,
the method comprising the steps of:
providing a sheet of expanded thermoplastic material with substantially open cells optionally containing at least one surfactant;
coupling a gas-barrier composite film onto a surface of said sheet of expanded thermoplastic material;
making a series of holes or slots in said sheet of expanded thermoplastic material in correspondence of at least part of its uncoupled surface, said holes or slots extending into at least part of the thickness of said sheet of expanded thermoplastic material, obtaining a perforated composite sheet;
forming the perforated composite sheet in such a way as to obtain a semi-finished tray having a bottom and side walls terminating in an edge and wherein said gas-barrier composite film defines the lower layer of said semi-finished tray; and
forming a peripheral frame of a plastic material having barrier properties with respect to the gas-diffusion to said semi-finished tray edge, the peripheral frame having substantially listel-like sides with an angular cross-section including two flanges of which one of said flanges juts out from the edge as a prolongation thereof, and the other engages the edge from beneath, thereby obtaining said tray.

41. A method according to claim 40, wherein the forming step of the peripheral frame to the semi-finished tray edge is carried out by a process comprising the steps of:
placing said semi-finished tray into a mould provided with cavities having predetermined shape and dimensions;
injecting a molten thermoplastic material into said cavities so as to have said thermoplastic material bonded by melting to the semi-finished tray edge, thereby obtaining to the edge a peripheral frame having substantially listel-like sides with an angular cross-section including two flanges of which one of said flanges juts out from the semi-finished tray edge, and the other engages the edge from beneath.

42. A method according to claim 40, wherein said coupling step is carried out by hot rolling said sheet of expanded thermoplastic material with said gas-barrier composite film.

43. A method of making a tray for use in a vacuum or modified atmosphere package for food products which are susceptible to release liquids and/or gases, the tray being made of plastic material, having a bottom, and sidewalls terminating with a jutting edge, the package comprising the tray and a cover for the tray consisting of a gas-barrier composite film, the tray comprising:
at least two layers, of which a layer facing inward of the tray consists of a sheet of a substantially open-cells expanded thermoplastic material having holes or slots on at least part of its upper surface, and a lower layer facing outward of said tray consists of a gas-barrier composite film;
a layer overlying said inward-facing layer and consisting of a unexpanded plastic material film or sheet or of a gas-barrier composite film having holes or slots on at least said bottom; and
a peripheral frame made of plastic material and having barrier properties with respect to the diffusion of gases, the peripheral frame being coupled to the tray edge all around the perimeter thereof and having substantially listel-like sides with an angular cross-section comprising two flanges of which a first flange juts out as a prolongation of the tray edge and a second flange engages the tray edge from beneath,
the method comprising the steps of:
providing a sheet of expanded thermoplastic material with substantially open cells optionally containing at least one surfactant;
coupling an unexpanded plastic material film or sheet onto a surface of said sheet of expanded thermoplastic material, thus obtaining a first composite sheet;
making a series of holes or slots in said first composite sheet in correspondence of at least part of the uncoupled surface of said unexpanded film or sheet, said holes or slots extending into at least part of the thickness of said sheet of expanded thermoplastic material, obtaining a first perforated composite sheet;
coupling a gas-barrier composite film made of plastic material onto the first perforated composite sheet in correspondence of the free surface of said sheet of expanded thermoplastic material, thus obtaining a second perforated composite sheet;
forming the second perforated composite sheet in such a way as to obtain a semi-finished tray having a bottom and side walls terminating in an edge and wherein said gas-barrier composite film defines the lower layer of said semi-finished tray; and
forming a peripheral frame of a plastic material having barrier properties with respect to the gas-diffusion to said semi-finished tray edge, the peripheral frame having substantially listel-like sides with an angular cross-section including two flanges of which one of said flanges juts out from the edge as a prolongation thereof, and the other engages the edge from beneath, thereby obtaining said tray.

44. A method according to claim 43, wherein the forming step of the peripheral frame to the semi-finished tray edge is carried out by a process comprising the steps of:
placing said semi-finished tray into a mould provided with cavities having predetermined shape and dimensions;
injecting a molten thermoplastic material into said cavities so as to have said thermoplastic material bonded by melting to the semi-finished tray edge, thereby obtaining to the edge a peripheral frame having substantially listel-like sides with an angular cross-section including two flanges of which one of said flanges juts out from the semi-finished tray edge, and the other engages the edge from beneath.

45. A method according to claim 43, wherein said coupling step of the unexpanded plastic material film or sheet with a surface of said expanded thermoplastic material sheet is carried out by hot rolling.

46. A method according to claim 43, wherein said coupling step of the said gas-barrier composite film of plastic material with said first perforated composite sheet is carried out by hot rolling.

47. A method of making a tray for use in a vacuum or modified atmosphere package for food products which are susceptible to release liquids and/or gases, said tray made of plastics material and having a bottom and sidewalls terminating with a jutting edge and comprising:
at least two layers, of which a layer facing inward of the tray consists of a sheet of a substantially open-cell expanded thermoplastic material having holes or slots on at least part of its upper surface, and a lower layer facing outward of said tray consists of a composite film having barrier properties with respect to the diffusion of gases;
the outward facing lower layer being engaged with the inward facing layer along all its lower surface and terminating with a portion jutting out of the tray edge as a prolongation thereof,
the method comprising the steps of:
providing a first sheet of expanded thermoplastic material with substantially open cells optionally containing at least one surfactant;
making a series of holes or slots in said first sheet of expanded thermoplastic material in correspondence of at least part of its surface, said holes or slots extending into at least part of the thickness of said first sheet of expanded thermoplastic material, obtaining a first perforated sheet;
forming the first perforated sheet in such a way as to obtain a first semi-finished tray having a bottom and side walls terminating in an edge and wherein the internal surface of said first semi-finished tray has said holes or slots;
providing a second sheet of expanded thermoplastic material;
coupling a gas-barrier composite film onto at least one surface of said second sheet of thermoplastic material, thereby obtaining a composite sheet;
forming the composite sheet to provide a second semi-finished tray terminating with an edge having an angular cross-section with two flanges, and wherein said gas-barrier composite film is facing inward of said second semi-finished tray; and
coupling said second semi-finished tray to the whole underside of said first semi-finished tray such that one of said two flanges engages the edge of said first semi-finished tray from beneath and the other juts out of the edge of said first semi-finished tray as a prolongation of said edge.

48. A method of making a tray for use in a vacuum or modified atmosphere package for food products which are susceptible to release liquids and/or gases, said tray made of plastics material and having a bottom and sidewalls terminating with a jutting edge and comprising:
at least two layers, of which a layer facing inward of the tray consists of a sheet of a substantially open-cell expanded thermoplastic material having holes or slots on at least part of its upper surface, and a lower layer facing outward of said tray consists of a composite film having barrier properties with respect to the diffusion of gases;
a layer overlying said inward-facing layer and consisting of an unexpanded plastic material film or sheet or of a gas-barrier composite film having holes or slots on at least said bottom;
the outward facing lower layer being engaged with the inward facing layer along all its lower surface and terminating with a portion jutting out of the tray edge as a prolongation thereof,
the method comprising the steps of:
providing a first sheet of expanded thermoplastic material with substantially open cells optionally containing at least one surfactant;
coupling an unexpanded plastic material film or sheet onto a surface of said first sheet of expanded thermoplastic material, thereby obtaining a first composite sheet;
making a series of holes or slots in said first composite sheet in correspondence of at least part of the surface of said unexpanded film or sheet, said holes or slots extending into at least part of the thickness of said first sheet of expanded thermoplastic material, obtaining a first perforated composite sheet;
forming the first perforated composite sheet in such a way as to obtain a first semi-finished tray having a bottom and side walls terminating in an edge and wherein said first sheet of expanded thermoplastic material with substantially open cells defines the lower layer of said first semi-finished tray;
providing a second sheet of expanded thermoplastic material;
coupling a gas-barrier composite film onto at least one surface of said second sheet of thermoplastic material, thereby obtaining a second composite sheet;
forming the second composite sheet to provide a second semi-finished tray terminating with an edge having an angular cross-section with two flanges, and wherein said gas-barrier composite film is facing inward of said second semi-finished tray; and
coupling said second semi-finished tray to the whole underside of said first semi-finished tray such that one of said two flanges engages the edge of said first semi-finished tray from beneath and the other juts out of the edge of said first semi-finished tray as a prolongation of said edge.
